(19) United States
(12) Patent Application Publication
(10) Pub. No.: US 2010/0227551 A1
(43) Pub. Date: Sep. 9, 2010

(54) Buoy supported underwater radio antenna

(76) Inventors: Mark Volanthen, Hampshire (GB); Mark Rhodes, West Lothian (GB); Brendan Peter Hyland, Edlnburgh (GB)

Correspondence Address: Goodwin Procter LLP;Attn: Patent Administrator, 135 Commonwealth Drive, Menlo Park, CA, 94025-1105, US

(21) Appl. No.: 12/752,856

(22) Filed: Apr. 1, 2010

Related U.S. Application Data
(63) Continuation-in-part of application No. 11/454,630, filed on Jun. 15, 2006, now Pat. No. 7,711,322.
(60) Provisional application No. 60/690,964, filed on Jun. 15, 2005.
(60) Provisional application No. 60/690,966, filed on Jun. 15, 2005.
(60) Provisional application No. 60/690,959, filed on Jun. 15, 2005.

(51) Int. Cl. H04B 13/02; H01Q 1/34

(52) U.S. Cl. 455/40; 343/709

(57) ABSTRACT

The present invention provides a buoy supported antenna for underwater radio communications. The antenna of the present invention comprises an elongate section submerged in water and a feed point for feeding electrical signals to the antenna located on the elongate section, the elongate section is attached to an underwater object at a first end thereof, and during deployment is suspended by a buoy at a second end thereof so that the elongate section is substantially self supporting and vertical in orientation. At least a first portion of the elongate section comprises a flexible wire having an electrically conductive core, which is electrically insulated on an outer surface thereof. During operation the flexible wire radiates electromagnetic signals through the water.

### CROSS-REFERENCE TO RELATED APPLICATION

This application is a continuation in part of U.S. Ser. No. 11/454,630, which claims the benefit of U.S. Ser. Nos. 60/690,964, 60/690,966, and 60/690,959, all filed Jun. 15, 2005. This application is also related to commonly owned, concurrently filed U.S. Ser. No. ______, entitled Underwater Radio Antenna, Attorney Docket No. WIR 0040. All of the above applications are fully incorporated herein by reference.

### FIELD OF USE

The present invention relates to the field of antennas for wireless communications by electromagnetic signaling in an underwater environment.

### DESCRIPTION OF THE RELATED ART

Wireless communications and data transfer in an underwater environment using radio signaling is preferable over other prior art wireless means for communications, for example by means of acoustic signaling or optical signaling. The benefits of radio signaling over acoustic signaling are the elimination of noise caused by reflections of the signal from hard objects, a significant absence of Doppler effects, and the opportunity to use mature protocols and systems for establishing the radio channel. The benefits of radio signaling over optical signaling are the elimination of local attenuation of the signal arising from turbidity, the elimination of a need for line-of sight. Moreover, systems based on radio communications can operate over multiple co-existing channels without interference.

Prior art antennas for radio communications between submerged objects employ surface antennas. Typically such antennas maintained in position by a floating apparatus, or are of sufficiently low density so that the antenna will float on the surface of the water. For example, U.S. Pat. No. 3,999,183 “Floatable radio antenna”; Brett, describes an antenna which is located on the surface of the sea and which is kept on the surface by means of a floating apparatus and U.S. Pat. No. 5,406,294 “Floating Antenna System” Silvey et al describes a floating antenna.

Underwater installations or vehicles which are positioned on or near the surface of the water can communicate using radio signals by employing antennas which float on the surface of the water, and which are electrically connected to submerged transceivers. For applications where the installations or vehicles are located well below the surface, such antennas are not practical.

U.S. Pat. No. 4,992,786 “Electrical conductor detector”; Kirkland, describes a system for object location which is based on the transmission of an electromagnetic pulses by an underwater cable. However, the system taught by Kirkland provides extremely low efficiency transmission by the underwater cable and is not suitable for conventional radio communications.

Commonly assigned U.S. patent application Ser. No. 11/454,630, “Underwater Communications System and Method”, Rhodes et al., previously incorporated herein by reference, describes a system for communicating underwater by means of low frequency electromagnetic signaling underwater. The system of commonly assigned U.S. patent application Ser. No. 11/454,630 is operable at any depth underwater, not just where the corresponding transceivers are located at or near the surface of the water.

Nonetheless, the high electrical conductivity of seawater creates problems for the transmission of electromagnetic signals in the radio spectrum. A typical value for the conductivity of seawater is 4 S.m⁻¹. This high electrical conductivity produces a correspondingly high rate of attenuation with distance of a radio signal. For a highly conducting medium—such as seawater, an approximate relationship between the attenuation co-efficient of a radio signal α, the angular frequency of the signal ω and the conductivity of the medium through which the signal propagates σ is given by Equation 1A.

$$α = \sqrt{\frac{ω μσ}{2}} \qquad Equation 1 A$$

Equation 1B gives the attenuation in dB per meter of a propagating signal and is derived directly from Equation 1A.

Attenuation [dB/m]=(\sqrt{πμσ}20 Log(e))\sqrt{f} Equation 1B

Thus, it can be seen from Equation 1B that the attenuation of a periodic signal increases with the square root of the frequency. Equation 2 gives an expression for the attenuation of a radio signal propagating in seawater having an electrical conductivity of 4 S.m⁻¹.

Attenuation in Seawater [dB/m]=0.03452\sqrt{f}Equation 2

To reduce the rate of attenuation with distance of a radio signal, systems which are based on underwater radio communications use low carrier frequencies. For example, systems based on frequencies in the range from 10 Hz to 10 MHz are proposed in U.S. patent application Ser. No. 11/454,630.

Systems based on low frequency propagation may use magnetically coupled antennas, which provide near-field communications through near-field terms of an electromagnetic or radio signal. Such antennas can be relatively compact compared to antennas which excite the electric field component of a radio signal. However, electrically small magnetically coupled antennas are inefficient at launching a radiating signal which can propagate over a large distance. In order to launch a radiating wave, it is necessary to use an antenna which excites the electric field component of a radio signal.

For the propagation of an electromagnetic wave over distances significantly beyond the near field, antennas having dimensions in the order of one half of one wavelength are required.

Similarly, for the propagation of electromagnetic signals over a long range in a horizontal direction, antennas which are vertically orientated are preferred, as the radiating field pattern from a vertical antenna is uniform in the horizontal directional.

However, such large vertical structures are difficult to deploy in an underwater environment. Moreover, large vertical underwater structures are prone to damage from the high currents and other effects produced by the harsh environment underwater. This is particularly the case in seawater where strong currents and the effects of turbidity can introduce sever mechanical stresses on man-made structures. The cost of erecting a vertical antenna resilient to the harsh environment underwater is another prohibiting factor against their deployment.

### SUMMARY OF THE INVENTION

An object of the present invention is to provide an antenna for underwater communications or data transfer which efficiently radiates low-frequency electromagnetic signals underwater.

A further object of the present invention is to provide an antenna for radiating low-frequency electromagnetic signals which, during deployment, is substantially vertically orientated and which is self supporting.

Another object of the present invention is to provide an antenna for radiating low-frequency electromagnetic signals which can be easily deployed in an underwater environment.

Yet another object of the present invention is to provide a flexible antenna for radiating low-frequency electromagnetic signals which is resilient to the harsh environment underwater, and other subsea conditions that would stress a rigid structure.

Accordingly, the present invention provides a buoy supported antenna for underwater radio communications. The antenna of the present invention comprises an elongate section submerged in water and a feed point for feeding electrical signals to the antenna located on the elongate section, the elongate section is attached to an underwater object at a first end thereof, and during deployment is suspended by a buoy at a second end thereof so that the elongate section is substantially self supporting and vertical in orientation. A first portion of the elongate section comprises a flexible wire having an electrically conductive core, which is electrically insulated on an outer surface thereof. During operation the flexible wire radiates electromagnetic signals through the water.

Embodiments of the present invention will now be described in detail with reference to the accompanying figures in which:

### BRIEF DESCRIPTION OF DRAWINGS

FIG. 1 shows a remotely operated vehicle (ROV) in wireless communications with an underwater hydrocarbon production or drilling facility. The remotely operated vehicle of FIG. 1 employs a buoy supported underwater antenna according to the present invention.

FIG. 2 shows a lower blow-out preventer stack in wireless communications with an underwater hydrocarbon production or drilling facility. The blow-out preventer stack of FIG. 2 employs a buoy supported underwater antenna according to the present invention.

FIG. 3A shows a centre-fed buoy supported antenna for underwater applications according to an embodiment of the present invention.

FIG. 3B shows an enlarged view of the feeding section of the buoy supported antenna of FIG. 3A.

FIG. 4 shows an end-fed buoy supported antenna for underwater applications according to another embodiment of the present invention.

FIG. 5 shows a buoy supported antenna according to an embodiment of the present invention which incorporates a reel mechanism so that the antenna can be deployed and retracted as required.

### DETAILED DESCRIPTION

According to a first aspect, the present invention provides an antenna for underwater radio communications comprising an elongate section submerged in water and a feed point for feeding electrical signals to said antenna located on said elongate section, said elongate section being attached to an underwater object at a first end thereof, and during deployment being suspended by a buoy at a second end thereof so that said elongate section is substantially self supporting and vertical in orientation; a first portion of said elongate section comprising a flexible wire having an electrically conductive core, and being electrically insulated on an outer surface thereof; wherein during operation said flexible wire radiates electromagnetic signals through the water.

In some embodiments, the antenna of the present invention further comprises a signal feed line which feeds electrical signals to or from the antenna and which is coupled to the antenna at said feed point.

The signal feed line may be a coaxial signal line; alternatively, a balanced signal line may be employed. In embodiments employing a coaxial signal line, a balun is optionally disposed between said coaxial signal line and said feed point.

The signal feed line may be connected to said first end of said elongate section of said antenna or at a point between said first end and said second end of said elongate section of the antenna of the present invention.

A feed section is optionally disposed between said signal feed line and said feed point.

In one embodiment, a second portion of said elongate section comprises a flexible wire having electrically conductive core, at least one electrically insulating region, an electrically conductive screen and further comprises an electrically conductive counterpoise; where each of said core, said insulating region, said screen and said counterpoise are coaxially disposed. Preferably, during operation, said second portion said elongate section radiates electromagnetic signals through the water.

In another embodiment, a second portion of said elongate section comprises a pair of spaced apart flexible wires, each of said spaced apart flexible wires having an electrically conductive core and being electrically insulated on an outer surface thereof.

In some embodiments, said first portion of said elongate section has an electrical length which is equal to one half of one wavelength of a centre frequency of operation of the antenna. In other embodiments, said first portion of said elongate section has an electrical length which is equal to one quarter of one wavelength of a centre frequency of operation of the antenna.

In some embodiments, said elongate section has an electrical length which is equal to an integer multiple of one quarter of one wavelength of a centre frequency of operation of the antenna of the present invention.

In some embodiments, during deployment, said elongate section is orientated within an angular range of +/−20 degrees from vertical.

In some embodiments, radio communications takes place by electromagnetic signals having a frequency in the range from 10 Hz to 10 MHz.

In some embodiments, said underwater object is an underwater remotely operated vehicle. In other embodiments, said underwater object is a part of an underwater hydrocarbon extraction or drilling facility. In yet other embodiments, said underwater object is a fixed underwater installation.

Optionally, said buoy is wholly submerged in water. Further optionally, said elongate section is buoyant in water.

In some embodiments, the antenna of the present invention further comprises a reel mechanism for deployment and retraction of the antenna. Deployment and/or retraction of the antenna may be controlled remotely. Furthermore, the reel mechanism may be motorised.

In one embodiment, said buoy comprises a self inflating mechanism.

According to a second aspect, the present invention provides a system for wireless communications or wireless data transfer underwater comprising an antenna; said antenna comprising an elongate section submerged in water and a feed point for feeding electrical signals to said antenna located on said elongate section, said elongate section being attached to an underwater object at a first end thereof, and during deployment being suspended by a buoy at a second end thereof so that said elongate section is substantially self supporting and vertical in orientation; a first portion of said elongate section comprising a flexible wire having an electrically conductive core, and being electrically insulated on an outer surface thereof; wherein during operation said flexible wire radiates electromagnetic signals through the water.

The high electrical conductivity of seawater produces a substantial reduction in the wavelength of a radio signal compared to the wavelength of the same signal propagating through air or through a vacuum.

The wavelength of an electromagnetic signal in a conducting medium is given by Equation 3.

$$λ = 2 π \sqrt{\frac{2}{ωμσ}} \qquad Equation 3$$

where ω is the angular frequency of the signal, μ is the magnetic permeability of the medium through which the signal propagates and σ is the electrical conductivity of the medium.
The wavelength of an electromagnetic signal propagating in seawater is given by Equation 4.

$${λ}_{SEAWATER} = 1581 \frac{1}{\sqrt{f}} \qquad Equation 4$$

Efficient communications over a long range by radiating electromagnetic waves requires the use of antennas with dimensions in the order of one half of one wavelength or more. For communications in air, this requirement renders the use of low frequencies—E.G. 100 Hz to 10 kHz—problematic as the antennas required are extremely large. A benefit of communications by electromagnetic signals in seawater is that an antenna with dimensions in the order of one half of one wavelength underwater is realizable even for such low frequency signals. For example: at 10 KHz, the wavelength is only 16 meters in seawater compared to 30 kilometers in air; at 1 KHz, the wavelength is only 50 meters in seawater compared to 300 kilometers in air; at 100 Hz the wavelength is only 160 meters in seawater compared to 3,000 kilometers in air.

By co-incidence, these frequencies are precisely those which are sufficiently low to provide a good range for a radio signal propagating in seawater. For example, radio signals having a carrier frequency of 1 kHz can be received at ranges in the order of hundreds of meters from the source provided the signal is transmitted by a highly efficient antenna and is similarly received by a highly efficient antenna.

Half-wave dipoles are efficient antennas for producing radiating electromagnetic fields. Half-wave dipole antennas can be fed at the centre, where the impedance is low, or can be fed at one end where the impedance is high. Typically, dipole antennas are fed by an unbalanced line, such as a co-axial line. A centre-fed dipole comprises a feed at the centre point, and a device to transform the single-ended feed line to a balanced feed line. Centre feeding is common, as it is easy to match the impedance of the antenna at the centre (where the current is high and the voltage is low) to the low impedance feed line. End-fed dipoles are also common. An end-fed dipole comprises a feed at one end and typically are designed to incorporate matching between the feed line and the very high impedance at the extreme ends of the antenna.

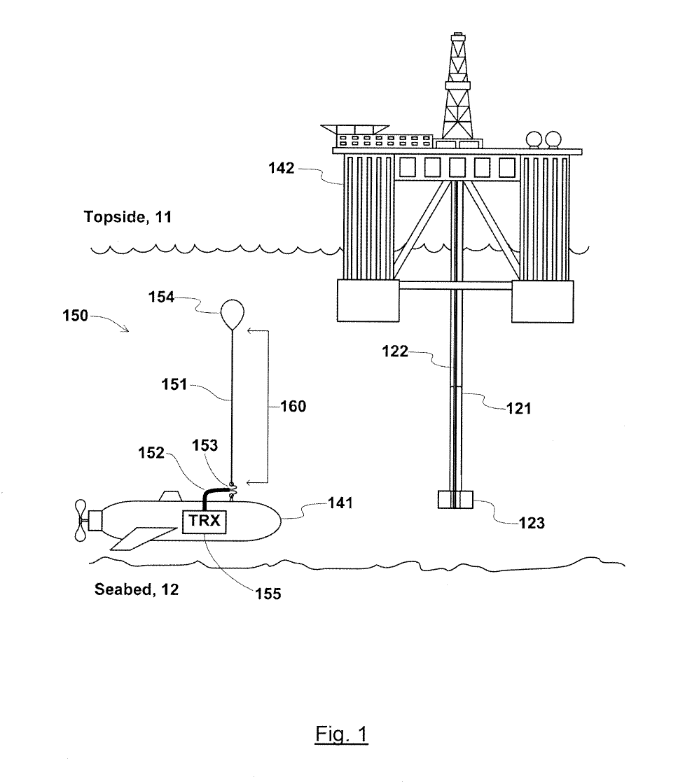

FIG. 1 shows a remotely operated vehicle 141 in wireless communications with an underwater hydrocarbon production or drilling facility 142. The remotely operated vehicle 141 of FIG. 1 employs an antenna 150 according to the present invention.

The antenna 150 of the present invention depicted in FIG. 1 comprises an elongate section 160 comprising a flexible wire 151 having an electrically conductive core. The flexible wire 151 of elongated section 160 is electrically insulated on the outside so as to isolate the wire from the electrical effects of the surrounding water. For example, the flexible wire 151 may be formed of a thin copper wire core having an insulating plastic jacket. A first end of elongate section 160 is attached to a remotely operated vehicle 141. A second end of the elongate section 160 is attached to a buoy 154, which supports elongated section 160 and flexible wire 151 in a vertical orientation. A signal carrying line 152 connects antenna 150 to transceiver 155. Signal carrying line 152 is connected to flexible wire 151 of elongate section 160 via a feed network 153 which feeds electrical signals from signal carrying line 152 to antenna 150 and vice versa. Feed network 153 may comprise a balun for converting a single-ended signal of signal carrying line 152 to a balanced signal. Alternatively, feed network 153 may comprise passive components to match the impedance of antenna 150 to signal carrying line 152.

The vertically suspended antenna 150 is optimally orientated to launch an electromagnetic signal that radiates substantially uniformly in the horizontal direction. Electromagnetic signals transmitted by buoy supported antenna 150 may be received by receivers (not shown) comprising similar antennas, or by a receiver of hydrocarbon production or drilling facility 142. For example, hydrocarbon production or drilling facility 142 comprises riser 121 and umbilical 122. Riser 121 and umbilical 122 are connected to lower marine riser package 123 at a lower end thereof. A transceiver (not shown) may be mounted along the length of riser 122, and a vertically oriented antenna (not shown) may be employed to receive electromagnetic signals transmitted by buoy supported antenna 150 of the present invention.

Electromagnetic signals transmitted by buoy supported antenna 150 may similarly be received by other underwater receivers (not shown) comprising electrically small antennas.

During deployment, the orientation of antenna 150 may drift slightly from vertical. For example, currents in the water may cause buoy to drift laterally. Similarly, movement of underwater vehicle 141 may produce a drag on buoy 154 so that antenna 150 drifts from absolute vertical alignment. Nonetheless, provided that the antenna of the present invention stays within an angle of +/−20 degrees from vertical, the benefits of improved radiation efficiency over an extended range are still available.

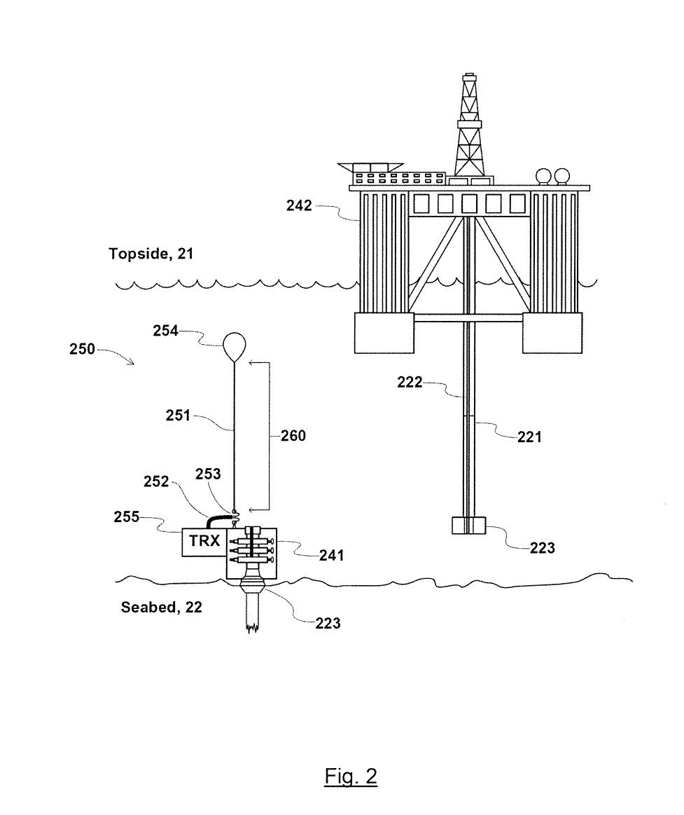

FIG. 2 shows a lower blow-out preventer stack 241 in wireless communications with an underwater hydrocarbon production or drilling facility 242. The lower blow-out preventer stack 241 being connected to a wellhead 223 of an underwater hydrocarbon extraction or drilling facility located on the seabed 22. A transceiver 255 attached to lower blow-out preventer stack 241 sends and receives electrical signals to an underwater antenna 250 according to the present invention.

The antenna 250 comprises an elongate section 260 comprising a flexible wire 251 having an electrically conductive core. The flexible wire 251 of elongate section 260 is electrically insulated on an outer surface thereof. Elongate section 260 is attached to lower blow-out preventer stack 241 at a first end thereof. Similarly, elongate section 260 is attached to a buoy 254 at a second end thereof. Buoy 254 maintains antenna 250 in a vertical orientation. Electrical signals are passed to and from flexible wire 251 of elongate section 260 via a signal carrying line 252. Signal carrying line 252 is terminated into a feed network 253 which feeds the electrical signals from the transceiver 255 to buoy supported antenna 250. Feed network 253 may comprise a balun for converting a single-ended signal of signal carrying line 252 to a balanced signal. Alternatively, feed network 253 may comprise passive components. The vertically suspended antenna 250 is optimally orientated to launch an electromagnetic signal that radiates uniformly in the horizontal direction. Electromagnetic signals transmitted by buoy supported antenna 250 may be received by receivers (not shown) comprising similar antennas, or by a receiver of hydrocarbon production or drilling facility 242.

For example, hydrocarbon production or drilling facility 242 comprises riser 221 and umbilical 222. Umbilical 222 is connected to lower marine riser package 223 at a lower end of riser 221. A transceiver (not shown) may be mounted along the length of riser 222, and a vertically oriented antenna (not shown) may be employed to receive electromagnetic signals transmitted by buoy supported antenna 250 of the present invention.

Electromagnetic signals transmitted by buoy supported antenna 250 may similarly be received by other underwater receivers (not shown) comprising electrically small antennas.

A number of designs for an end fed dipole antenna are suitable for use in the present invention. A coaxial fed half-wavelength dipole antenna is one such suitable antenna design. This antenna comprises upper and a lower quarter wavelength sections, where a coaxial feed is passed through lower quarter wavelength section. An alternative design comprises an end-fed half wavelength antenna comprising a quarter wavelength current balun and matching section disposed between the feed line and the antenna. Both types of antenna are most efficient when they are deployed so that all sections are substantially co-linear.

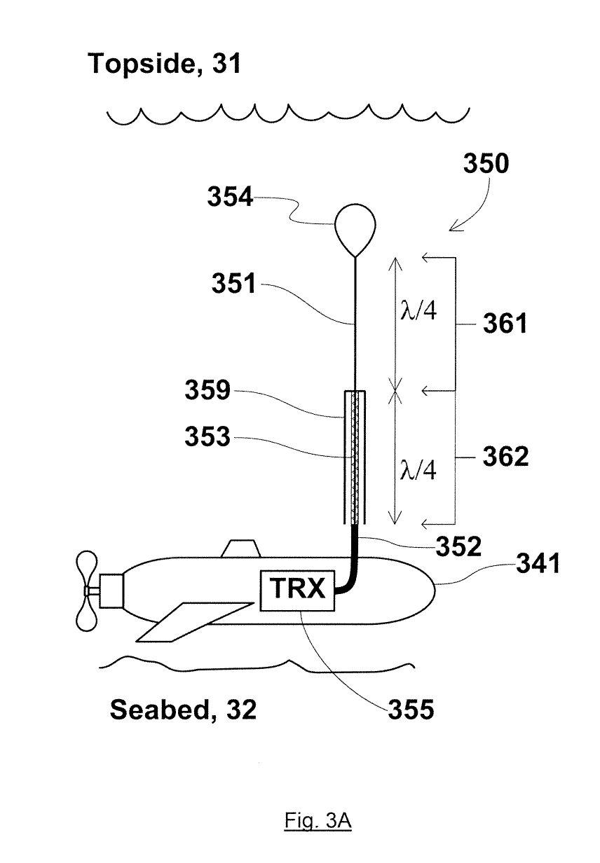

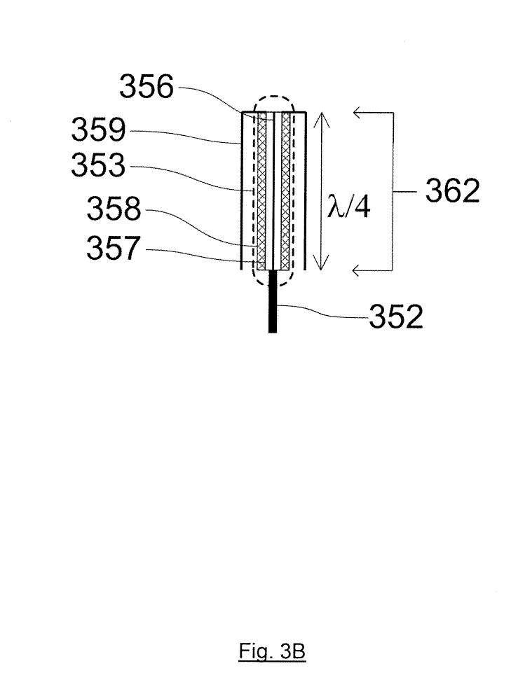

FIG. 3A shows a centre-fed buoy supported antenna 350 for underwater applications according to an embodiment of the present invention. The antenna of FIG. 3A comprises an elongate section comprising a first portion 361 formed of a flexible wire 351 and further comprising a second flexible portion 362. A first end of the elongate section comprising first portion 361 and second portion 362 is attached to underwater vehicle 341. Antenna 350 is supported by floating buoy 354. Floating buoy is attached to a second end of the elongate section comprising first portion 361 and second portion 362. Floating buoy 354 is a formed of a light flexible outer skin, which is filled with gas and which is sealed. Alternatively, floating buoy may be a rigid structure enclosing a gas or vacuum. In any case, the average density of floating buoy 354 is lower than that of the surrounding water. Electrical signals are fed to and from a transceiver 355 to antenna 350 via feed line 352. Feed line 352 is typically a co-axial feed line, though a balanced feed line may optionally be employed. Flexible wire 351 has an electrically conductive inner core and an electrically insulated coating (not shown).

The length of flexible wire 351 is approximately one quarter of one wavelength of the centre frequency of the radio signals to be transmitted by the antenna 350.

Second elongate section portion 362 has a length that also is approximately one quarter of one wavelength of the centre frequency of the radio signals to be transmitted by the antenna 350. A feeding section 353 is disposed between feed line 352 and a feed point of the antenna where second elongate section portion 362 joins with first elongate section portion 361. Feeding section 353 electrically connects feed line 352 and antenna 350. Thus, feeding section 353 provides a feeding point of the antenna 350 at the centre thereof.

Second elongate section portion 362 comprises a cylindrical counterpoise 359 surrounding feeding section 353. Cylindrical counterpoise 359 is electrically connected to antenna 350 at the position where second elongated section 362 meets first elongated section 361. The combination of first elongate section portion 361 formed of insulated flexible wire 351 and second elongated section portion 362 comprising counterpoise 359 and containing feeding section 353 forms a centre fed one half wavelength antenna. Cylindrical counterpoise 359 is coated on the outside with an electrically insulating material (not shown).

In operation, first elongate section portion 361 formed of insulated flexible wire 351 and second elongate section portion 362 comprising counterpoise 359 together radiate electromagnetic signals.

The antenna of the present invention shown in FIG. 3A is particularly suited to underwater communications and/or data transfer by electromagnetic signals having a frequency in the range from 10 Hz to 10 MHz.

Flexible wire 351 of first elongate section portion 361 is ideally formed from materials so that the average density thereof is less than that of water. The same applies to the constituent parts of second elongate section portion 362. Thus, the antenna of the present invention depicted in FIG. 3A is easily deployed underwater.

In the drawing of FIG. 3A first and second elongate section portions 361, 362 are intentionally drawn with enlarged lateral dimensions for illustrative purposes. In physical embodiments, these elements would each be sufficiently thin to maintain flexibility and lightness of the antenna.

FIG. 3B shows an enlarged view of the feeding section 353 of antenna 350 of FIG. 3A. Feeding section 353 comprises a central core 356 of an electrically conductive material, surrounded by a cylindrical region 357 of an electrically insulating material and further surrounded by a cylindrical screen 358 of an electrically conductive material. The combination of central core 356 surrounded by cylindrical region 357 and further surrounded by a cylindrical screen 358 may in some cases be formed of a section of co-axial cable.

In the drawing of FIG. 3B the elements of feeding section 353 are intentionally drawn with enlarged lateral dimensions for illustrative purposes. In physical embodiments, these elements would each be sufficiently thin to maintain flexibility and lightness of the antenna.

The use of low density materials for first elongated section portion 361 comprising flexible wire 351 and for second elongate section portion 362 ensures that buoy support 354 is able to provide the required buoyancy to keep the antenna of FIG. 3A upright. In particular, an appropriate choice of materials, as would be known to a person skilled in the art, ensures that the size of buoy support 354 does not become prohibitively large. Moreover, the use of highly flexible materials for first elongated section portion 361 comprising flexible wire 351 and for second elongate section portion 362 ensures that the force required to maintain antenna 350 in a vertical orientation does not provide excessive lift on underwater vehicle 341.

In practical implementations, the length of first elongated section portion 361 and or the length of second elongate section portion 362 may differ from one quarter of one wavelength of the frequency of operation of the antenna. For example, the second elongate section portion 362 may be designed with a shorter length, and may comprise inductive matching to provide an antenna having a second elongate section portion 362 with an effective length of one quarter of one wavelength. Similarly, passive components and design techniques as would be known to a person skilled in the art may be employed to shorten the length of first elongate section portion 361. The use of such techniques, still provides an antenna having first and second elongate section portions 361, 362 having effective electrical lengths of one quarter of one wavelength at the centre frequency of operation of the antenna.

Matching techniques may also be employed at transceiver 355 to match an antenna having an first elongate section portion 361 and/or a second elongate section portion 362 where the physical length is greater than or less than one quarter of one wavelength at the centre frequency of operation of the antenna.

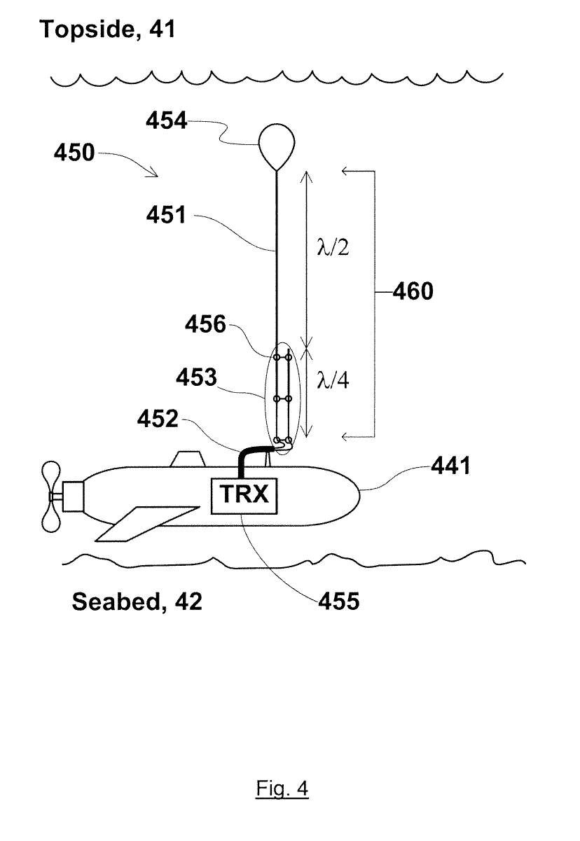

FIG. 4 shows an end-fed buoy supported antenna 450 for underwater applications according to another embodiment of the present invention. The antenna of FIG. 4 comprises an elongate section 460 and is attached to an underwater vehicle 441 at a first end thereof. A first portion of elongate section 460 is formed of a flexible wire 451. The antenna of FIG. 4 is supported by floating buoy 454 at a second end of elongate section 460. Electrical signals are passed to and from a transceiver 455 to antenna 450 via feed line 452. Feed line 452 is typically a co-axial feed line, though a balanced feed line may optionally be employed. Flexible wire 451 has a electrically conductive inner core and an electrically insulated coating (not shown). The length of flexible wire 451 is approximately one half of one wavelength of the centre frequency of the radio signals to be transmitted by antenna 450.

A second portion of elongate section 460 comprised feed section 453. Feed section is disposed between signal feed line 462 and flexible wire 451. Feed section 453 is approximately one quarter of one wavelength long and comprises a pair of flexible wires separated by spacers 456. Spacers 456 are employed to maintain a fixed characteristic impedance of feed section 453. The feed section 453 provides single ended to balanced conversion to eliminate return currents that might otherwise be induced on feed line 452. Feed section 453 is also electrically insulated on the outside.

In operation, first portion of elongate section 460 which is formed of a flexible wire 451 radiates electromagnetic signals.

The antenna of the present invention shown in FIG. 4 is particularly suited to underwater communications and/or data transfer by electromagnetic signals having a frequency in the range from 10 Hz to 10 MHz.

Flexible wire 451 is ideally formed from materials so that the average density is less than that of water. For example, the electrically conductive core may be of copper, and the insulated coating may be a polymer having a density less than 1000 kg m⁻³ so that the combined average density of the core plus insulation is less than that of water. The same applies to the pair of flexible wires and spacers 456 which form feed section 453. Thus, the antenna of the present invention depicted in FIG. 4 is easily deployed underwater.

Buoy support 454 comprises a bladder filled with a gas so as to provide the required buoyancy to keep antenna 450 upright and vertically orientated.

In some cases, the antenna 450 of FIG. 4 is more efficient than the antenna of FIG. 3A due to its increased length, and the greater spacing of the antenna from underwater vehicle 441.

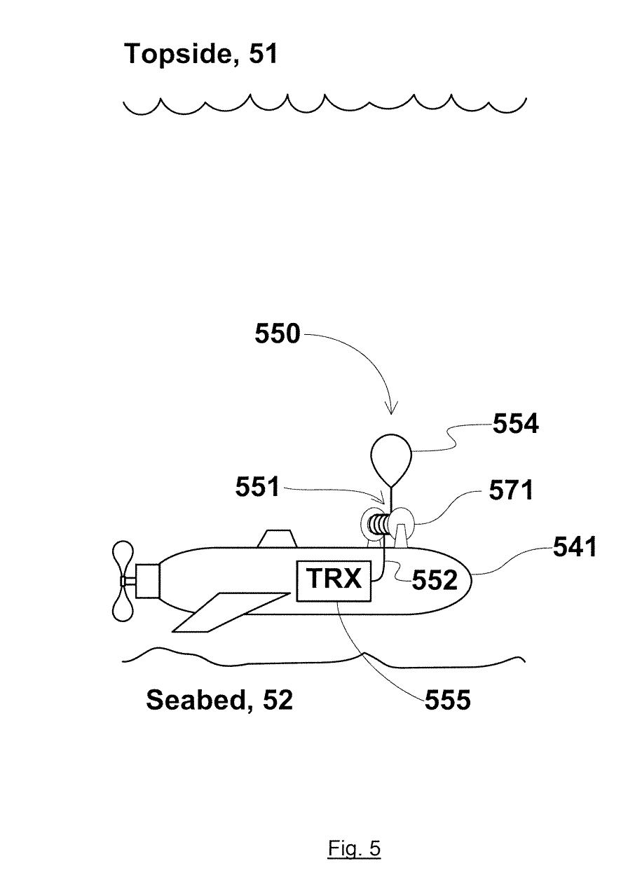

FIG. 5 shows a buoy supported antenna 550 according to an embodiment of the present invention which incorporates a reel mechanism 571 so that the antenna can be deployed and retracted during use as required.

The antenna of FIG. 5 is attached to an underwater vehicle 541. Antenna 550 comprises an elongated section formed of a flexible wire 551 which is wrapped around reel mechanism 571. One end of flexible wire 551 is connected to floating buoy 554. Flexible wire 551 has an electrically conductive inner core and an electrically insulated coating (not shown). When extended, the length of flexible wire 551 is approximately one half of one wavelength of the centre frequency of the radio signals to be transmitted by the antenna 550 of FIG. 5.

Antenna 550 is deployed by unwinding reel mechanism 571. The unwinding of reel mechanism 571 may be powered, for example, by an electrical motor (not shown). Similarly, the unwinding of reel mechanism 571 may be triggered by a remotely control signal. For example, a control signal may be sent by transceiver 555 or by a control centre of underwater vehicle 541. After deployment, and during use, electrical signals are fed to and from a transceiver 555 to the antenna 550 via feed line 552. Antenna 550 may subsequently be retracted when the transmission of data or signals is no longer required.

The reel mechanism 571 of antenna 550 may be mounted on the outside of underwater vehicle 541 as shown in FIG. 5. Alternatively, the reel mechanism 571 may be mounted inside an underwater vehicle.

In a variation of the embodiment of the buoy supported antenna 550 of the present invention depicted in FIG. 5, buoy 554 may include a self inflating mechanism. Accordingly, the antenna is typically installed, with flexible wire 551 reeled in, and with buoy 554 deflated. At the time when the antenna is to be deployed, buoy 554 is inflated, and flexible wire 551 is reeled out. The inflation mechanism may include a gas canister, and inflation of the buoy may be triggered by a control command sent, for example, by transceiver 555 or by a control centre of underwater vehicle 541.

The antennas embodying the present invention depicted in FIG. 3A, FIG. 3B, FIG. 4 and FIG. 5 herein are suitable for use to transmit and receive radio signals to or from any underwater installation. For example, the antennas of FIG. 3, FIG. 3B, FIG. 4 and FIG. 5 may be deployed for use in fixed underwater installations, such as in sections of hydrocarbon production facilities or in sections of hydrocarbon drilling facilities. Similarly, the antennas of FIG. 3A, FIG. 3B, FIG. 4 and FIG. 5 may be deployed for use in underwater vehicles, such as remotely operated vehicles (ROV) or autonomous underwater vehicles (AUV).

Thus, the present invention embodied in the various figures and descriptions described herein provide an antenna for underwater communications which is substantially vertically orientated. The antenna of the present invention is self supporting and efficiently radiates low-frequency electromagnetic signals underwater. Moreover, the present further provides an antenna for radiating low-frequency electromagnetic signals which can be easily deployed in an underwater environment. The antenna of the present invention is flexible and is resilient to the harsh environment underwater, and other subsea conditions that would stress a rigid structure.

The antenna for underwater radio communications of the present invention may be used for the transmission of voice telephony, the transmission of static or video images, or the transfer of control commands. In general, the antenna for underwater radio communications of the present invention is suitable for the transmission of any form of data, that can be sent by radio communications. The term radio communications used herein does not impose any limitation on the scope of the present invention to data transfer between two or more people in the colloquial sense.

Embodiments of the buoy supported underwater radio antenna of the present invention are described herein with particular emphasis on seawater environments having a specific salinity and a corresponding specific electrical conductivity. However, any optimization of the present invention to suit particular water constitutions remains within the scope of the present invention.

The descriptions of the specific embodiments herein are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. An antenna for underwater radio communications comprising an elongate section submerged in water and a feed point for feeding electrical signals to said antenna located on said elongate section;
said elongate section being attached to an underwater object at a first end thereof, and during deployment being suspended by a buoy at a second end thereof so that said elongate section is substantially self supporting and vertical in orientation;
a first portion of said elongate section comprising a flexible wire having an electrically conductive core, and being electrically insulated on an outer surface thereof;
wherein during operation said flexible wire radiates electromagnetic signals through the water.

2. An antenna for underwater radio communications according to claim 1 further comprising a signal feed line which feeds electrical signals to or from said antenna via said feed point.

3. An antenna for underwater radio communications according to claim 2 wherein said signal feed line is a coaxial signal line.

4. An antenna for underwater radio communications according to claim 3 further comprising a balun disposed between said coaxial signal line and said feed point.

5. An antenna for underwater radio communications according to claim 2 wherein said signal feed line is a balanced signal line.

6. An antenna for underwater radio communications according to claim 2 wherein said signal feed line is connected to said first end of said elongate section of said antenna.

7. An antenna for underwater radio communications according to claim 2 wherein said signal feed line is connected at a point between said first end and said second end of said elongate section of said antenna.

8. An antenna for underwater radio communications according to claim 2 further comprising a feed section disposed between said signal feed line and said feed point.

9. An antenna for underwater radio communications according to claim 1, said elongate section further comprising a second portion having an electrically conductive core, at least one electrically insulating region, an electrically conductive screen and an electrically conductive counterpoise, each of said core, said insulating region, said screen and said counterpoise being coaxially disposed.

10. An antenna for underwater radio communications according to claim 9 wherein during operation said second portion of said elongate section radiates electromagnetic signals through the water.

11. An antenna for underwater radio communications according to claim 1, said elongate section further comprising a second portion comprising a pair of spaced apart flexible wires, each of said spaced apart flexible wires having an electrically conductive core and being electrically insulated on an outer surface thereof.

12. An antenna for underwater radio communications according to claim 1 said first portion of said elongate section having an electrical length which is equal to one half of one wavelength of a centre frequency of operation of said antenna.

13. An antenna for underwater radio communications according to claim 1 said first portion of said elongate section having an electrical length which is equal to one quarter of one wavelength of a centre frequency of operation of said antenna.

14. An antenna for underwater radio communications according to claim 1 said elongate section having an electrical length which is an integer multiple of one quarter of one wavelength of a centre frequency of operation of said antenna.

15. An antenna for underwater radio communications according to claim 1 wherein, during deployment, said elongate section is orientated within an angular range of +/−20 degrees from vertical.

16. An antenna for underwater radio communications according to claim 1 wherein radio communications takes place by means of electromagnetic signals having a frequency in the range from 10 Hz to 10 MHz.

17. An antenna for underwater radio communications according to claim 1 wherein said underwater object is an underwater remotely operated vehicle.

18. An antenna for underwater radio communications according to claim 1 wherein said underwater object is a part of an underwater hydrocarbon drilling or production facility.

19. An antenna for underwater radio communications according to claim 1 wherein said underwater object is an underwater installation fixed to the seabed.

20. An antenna for underwater radio communications according to claim 1 wherein said buoy is wholly submerged under water.

21. An antenna for underwater radio communications according to claim 1 wherein said elongate section is buoyant in water.

22. An antenna for underwater radio communications according to claim 1 further comprising a reel mechanism for deployment and retraction of the antenna.

23. An antenna for underwater radio communications according to claim 22 wherein deployment and retraction of the antenna is controlled remotely.

24. An antenna for underwater radio communications according to claim 22 wherein said reel mechanism is a motorized mechanism.

25. An antenna for underwater radio communications according to claim 1 wherein said buoy comprises a self inflating mechanism.

26. A system for wireless communications or wireless data transfer underwater comprising the antenna of claim 1.
